(19) United States
(12) Patent Application Publication
(10) Pub. No.: US 2008/0037041 A1
(43) Pub. Date: Feb. 14, 2008

(54) Device, method, and program storage medium for color conversion, and for generating color conversion coefficients

(75) Inventors: Noriko Hasegawa, Kanagawa (JP); Yasunari Kishimoto, Kanagawa (JP); Kiyoshi Une, Saitama (JP); Tomoko Taguchi, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., TOKYO (JP)

(21) Appl. No.: 11/785,383

(22) Filed: Apr. 17, 2007

(30) Foreign Application Priority Data
Aug. 9, 2006 (JP) 2006-216639

(51) Int. Cl. G06K 9/36

(52) U.S. Cl. 358/1.6; 358/1.9

(57) ABSTRACT

There is provided a color conversion device, including: an analyzer that analyzes color reproduction characteristics of a source device based on a source profile, and analyzes color reproduction characteristics of a destination device based on a destination profile; a determination section that, based on the result of the analysis, determines a color conversion function for converting an input image signal to an output image signal; and a converter that converts the input image signal to the output image signal, based on the determined color conversion function.

### CROSS-REFERENCE TO RELATED APPLICATIONS

This application is based on and claims priority under 35 USC 119 from Japanese Patent Application No. 2006-216639 filed Aug. 9, 2006.

### BACKGROUND

1. Technical Field

The present invention relates to a device, a method, and a program storage medium for color conversion, and a device, a method, and a program storage medium for generating color conversion coefficients. Specifically, the present invention relates to a device, a method, and a program storage medium for color conversion processing which is performed for color image signals especially when a source device and a destination device have different color-reproduction ranges from each other.

2. Related Art

As a usual method for adjusting colors between the input characteristics of a monitor or a scanner and the output characteristics of a printer and the like, there is a method that converts colors using the International Color Consortium (ICC) profile of a source (input end) device, and the ICC profile of a destination (output end) device. In the color conversion using the ICC profile, color signals in a color space depending on source devices are converted into color signals in a Lab color space which is independent of devices, and the converted signals are input into a multidimensional lookup table (DLUT) of a destination device for which color signals in the Lab color space are converted into color signals in a color space depending on the destination device. In this case, the color characteristics of the source device may be reproduced in the destination device. However, color conversion according to the reproduction ranges of the source device and the destination device, and color reproduction maintaining the characteristics of primary colors (pure colors) of the source device cannot be performed. Moreover, when the source device is changed while the destination device is fixed, different color reproduction is obtained even if the target for color reproduction is the same.

### SUMMARY

One aspect of the present invention is a color conversion device, including: an analyzer that analyzes color reproduction characteristics of a source device based on a source profile, and analyzes color reproduction characteristics of a destination device based on a destination profile; a determination section that, based on the result of the analysis, determines a color conversion function for converting an input image signal to an output image signal; and a converter that converts the input image signal to the output image signal, based on the determined color conversion function.

### BRIEF DESCRIPTION OF THE DRAWINGS

Exemplary embodiments of the present invention will be described in detail based on the following figures, wherein:

FIG. 1 is a block diagram showing an outline configuration of a color conversion device according to an exemplary embodiment of the present invention;

FIG. 2 is a flow diagram of processing executed in an analyzer;

FIG. 3 is a diagram showing one example of mapping table data;

FIG. 4 is a diagram showing another example of mapping table data;

FIG. 5 is a block diagram showing an outline configuration of a color conversion device according to another exemplary embodiment; and

FIG. 6 is a block diagram showing an outline configuration of a conventional color conversion device.

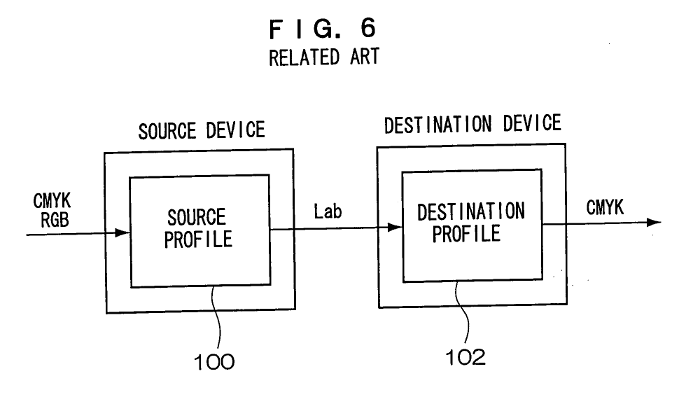

### DETAILED DESCRIPTION

Hereinafter, one example according to an embodiment of the present invention will be explained in detail by referring to the drawings.

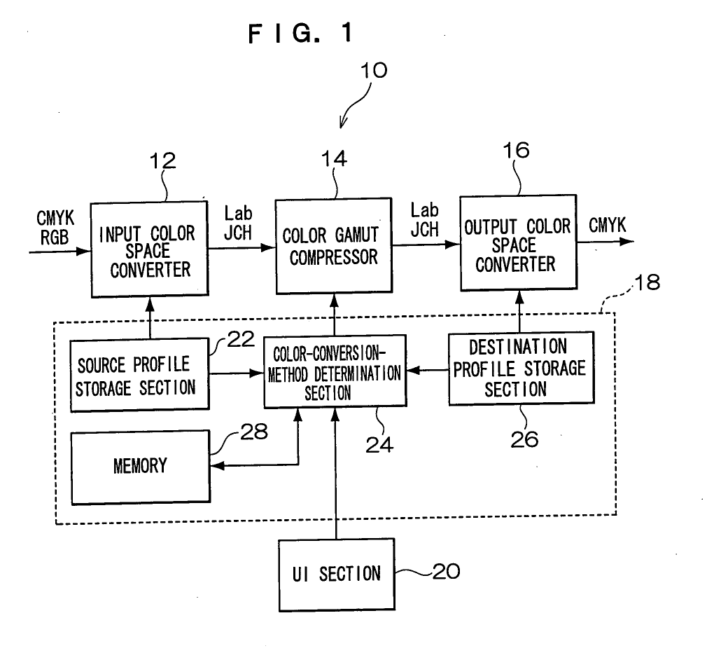

Firstly, the overall configuration of a color conversion device according to the exemplary embodiment will be explained. FIG. 1 is a block diagram showing an example of an overall configuration of the color conversion device according to the embodiment. The color conversion device which will be explained hereinafter may be installed for use in, for example, an image output device such as a digital copying machine and/or a printer, a server connected to the image output device, or a computer (driver device) which gives operation instructions to the image output device.

As shown in FIG. 1, the color conversion device 10 is provided with: an input color space converter 12; a color gamut compressor 14; an output color space converter 16; an analyzer 18; and a user interface (hereinafter, abbreviated as “UI”) section 20.

The input color space converter 12 converts an input image signal dependent on a source device into a device-independent image signal, based on a source (input) profile. The input image signal includes, for example, a color image signal in RGB (red, green, and blue) color space for display on a CRT and the like, a color image signal in CMYK (cyan, magenta, yellow, and black) color space, and the like. Moreover, the device-independent image signal includes, for example, a color image signal in Lab color space, a color image signal in JCH color space, and the like.

The color gamut compressor 14 performs color conversion of the device-independent input image signal output from the input color space converter 12 in a color conversion method determined by the analyzer 18, and the converted signal is output to the output color space converter 16.

The output color space converter 16 converts the device-independent image signal which is color converted by the color gamut compressor 14 into an output image signal dependent on a destination device, based on a destination (output) profile, and outputs the converted signal. The output image signal includes, for example, a color image signal in CMY color space or in the CMYK color space, which is used for printing in a printer and the like. The present embodiment will be described in a case in which the output image signal is a color image signal in the CMYK color space.

The analyzer 18, which will be described in detail later, analyzes the color reproduction characteristics of the source device and those of the destination device, based respectively on a source profile representing the color reproduction characteristics of the source device and a destination profile representing the color reproduction characteristics of the destination device, determines a color conversion method to be performed based on the analyzed result, and outputs the result to the color gamut compressor 14.

The analyzer 18 is configured to include: a source profile storage section 22; a destination profile storage section 26; a color-conversion-method determination section 24; and a memory 28. The source profile storage section 22 stores the source profile representing the color reproduction characteristics of the source device. The destination profile storage section 26 stores the destination profile representing the color reproduction characteristics of the destination device. The color-conversion-method determination section 24 analyzes the source profile and the destination profile, and based on the analyzed result and settings by a user, determines a color conversion method to be performed.

A UI section 20 is provided to be operated by a user and to set various kinds of settings relating to the analysis performed by the analyzer 18.

Each of the above components 12 through 18 is included in, for example, an image output device, a server, and/or a driver device. These components may be implemented by a computer provided with a combination of a central processing unit (CPU), a read only memory (ROM), a random access memory (RAM), and the like, by executing a predetermined program.

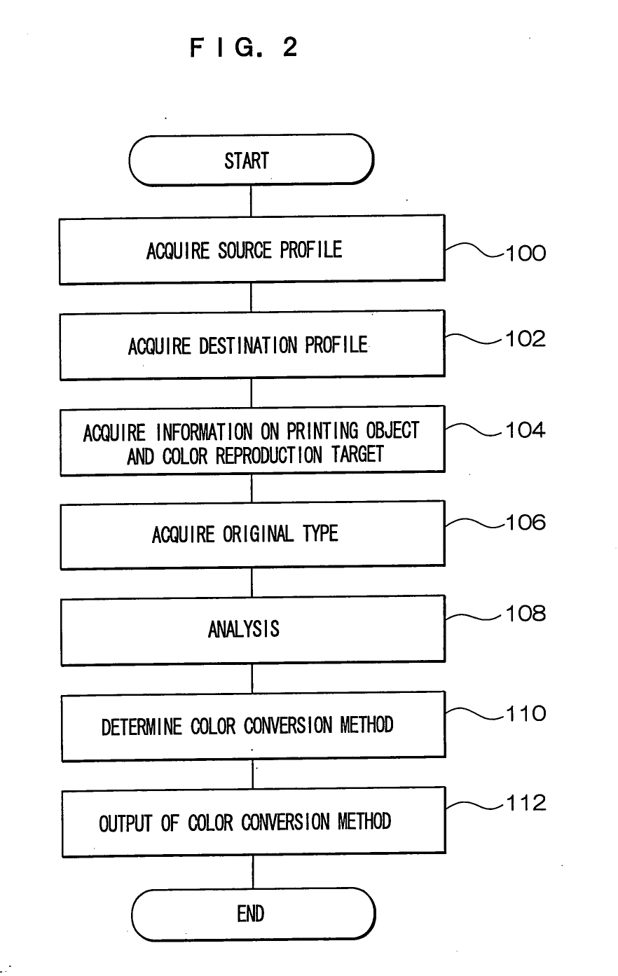

Next, a processing routine executed in the analyzer 18 will be explained, referring to a flow diagram shown in FIG. 2.

Firstly, the source profile is acquired by reading from the source profile storage section 22 at step 100.

In step 102, the output profile is acquired by reading from the destination output profile storage section 26.

In step 104, information about a color reproduction target such as an intent of printing is acquired. The color reproduction target may be, for example, set by a user through a setting screen (not shown) for setting the color reproduction target which is displayed on the UI section 20.

The color reproduction target includes, for example, three intents (perceptual, saturation, and relative colorimetric) defined by the ICC profile. These represent the features of color reproduction, such as monitor emphasis, chroma emphasis, gradation reproducibility, contrast and colorimetric matching, which are required in output environments demanded by a user. Here, the above-described intents may be analyzed using a predetermined analysis method when the color space of the source device is CMYK. Moreover, in addition to the above features, printing objects such as “monitor fidelity”, or “vividness”, printing (original) types such as “CAD” or “photograph”, and in particular designated colors which are specifically desired to be converted into a target hue or the target hue itself, primary colors (for example, Y, M, C) which are to be reproduced in pure color, or the like may be set as the color reproduction target.

In step 106, the printing type of an image for color conversion is acquired. The printing type may be set by a user using the setting screen (not-shown) for setting a printing type displayed on the UI section 20, or may be acquired by analyzing image data using a known technique. The printing (original) types include: “photograph”; “graphic”; “text”; “gradation” and the like, but the type is not limited to these.

In step 108, the characteristics of the source device and the destination device are analyzed based on the source profile and the destination profile.

Although there are various kinds of analyses, in the present exemplary embodiment, cases in which a lightness analysis, a gradation characteristic analysis, a primary color characteristic analysis, a CAM analysis, an analysis of the input color gamut volume of the source device or the output color gamut volume of the destination device is performed are described as examples. However, the kinds of analyses that may be performed in the embodiment are not limited to these.

For example, the lightness analysis may be performed when the input image signal and/or the output image signal are an image signal in the CMYK color space. For example, when the output image signal is an image signal in the CMYK color space, the reproducibility in a low lightness range is analyzed by comparing colors having low lightness in the color gamut of the destination, for example, colors of C, M, Y, K=(0, 0, 0, 100), (100, 100, 100, 0), and (100, 100, 100, 100), (that is, a color of 100% of K only, a color of 100% of C, 100% of M, and 100% of Y, and a color of 100% of C, 100% of M, 100% of Y, and 100% of K), with colors of a predetermined standard color gamut.

In the gradation characteristic analysis, for example, information representing a gamma (Γ) characteristic, for example a gamma (Γ) value, may be acquired from the source profile or the destination profile. Further, in the gradation characteristic analysis, halftone reproduction characteristics of saturated colors and intermediate colors of the primary colors may be obtained based on the profiles. Moreover, ranges in which gradation is deteriorate, and/or ranges in which gradation appears may be analyzed by comparing the halftone reproduction characteristics of the saturated colors and/or the intermediate colors with predetermined reference halftone reproduction characteristics.

In the primary color characteristic analysis, a color difference and/or a lightness difference between primary colors (Y, M, C, R, G, B, and the like) in the color gamut of the source device obtained from the source profile and the color gamut of the destination device obtained from the output profile may be determined.

In the CAM analysis, ambient light and a light source of the input image signal may be extracted by a predetermined method and analyzed to determine, for example, whether they are within a predetermined standard environment. Here, the ambient light is, for example, when the source device is a monitor, surrounding light under which an image displayed on the monitor is viewed, and the light source is a light source used for the monitor.

In the analysis of the color gamut volume, for example, when the source device is a monitor, the whole volume of the color gamut may be determined based on the source profile, and the determined volume compared with the whole volume of the standard color gamut such as sRGB (standard RGB) or WideRGB to obtain a magnitude correlation. Although the color gamut volume of the destination device can be similarly analyzed, when the color space of the destination device is CMYK, the determined volume is compared with the whole volume of a general color gamut such as Japan Color.

The above color gamut volume analysis may be performed not only by comparing the volumes of the whole color gamut, but also by comparing a part of the volumes of the color gamut, for example, the volumes between the hues of predetermined primary colors. Moreover, with regard to the color gamut of the destination device, the color gamut of the destination device may be compared, for example, with the color gamut volume of a device having a color gamut volume of LOW class, MID class, or HIGH class, or the volume of the color gamut having a higher or lower lightness than the maximum chroma may each be compared. Furthermore, the ratio of shared volume between the color gamuts of the source device and the destination one may be calculated.

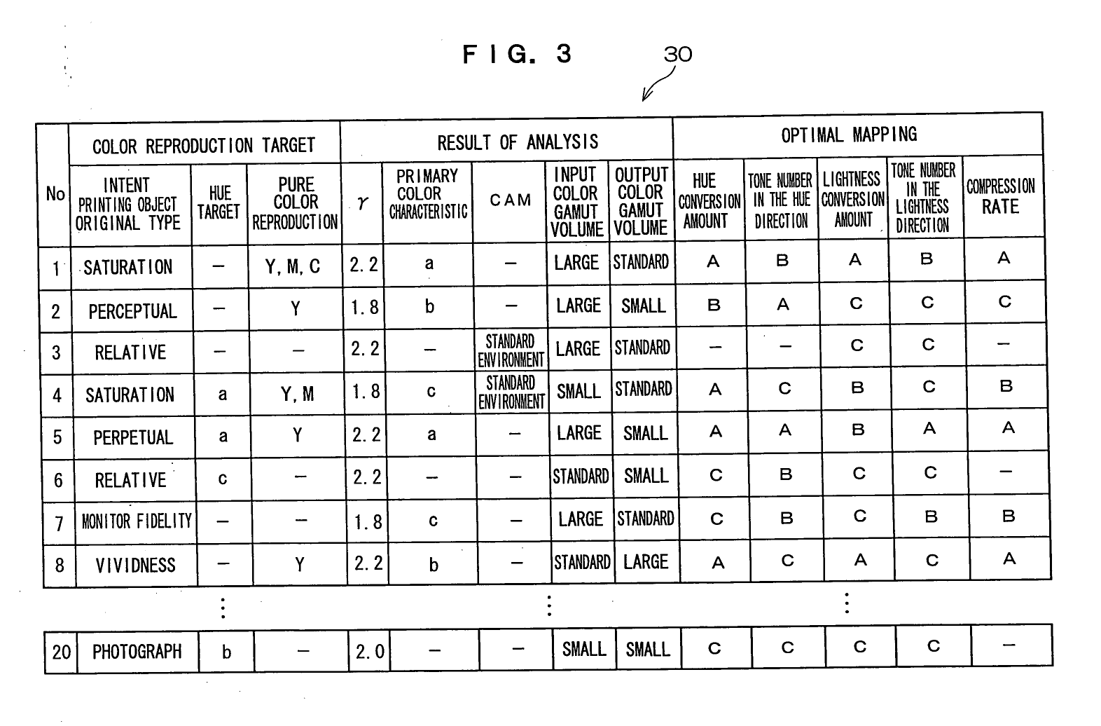

At step 110, the color conversion method is determined based on a color reproduction target including, for example, printing objects, intents, printing types, results of the analysis, and the like. Specifically, the method is determined, based on mapping table data representing correspondences between the color reproduction targets and the results of the analysis, and the optimal mapping methods thereto. FIG. 3 shows one example of the mapping table data which may be used to enable an optimal color reproduction according to the color reproduction target, even when the characteristics of the source device and those of the destination device are different.

As shown in FIG. 3, a mapping table data 30 indicates correspondences between the color reproduction targets, the results of the analysis, and the optimal mapping methods, and by selecting a case number corresponding to the color reproduction target and the result of the analysis (analytical items), which are obtained as described above, the optimal mapping method corresponding to the case number is determined to be the color conversion method.

Referring to FIG. 3, a hue target of the color reproduction target is a difference between the hue of the input image signal and the target hue, and is denoted by three levels of a through c (a>b>c) in this example. Further, a primary color characteristic of the result of the analysis is a color difference or a lightness difference between a primary color in the color gamut of the source device and a primary color in the color gamut of the destination device, as described above, and is denoted by three levels of a through c (a>b>c) in a similar manner to the hue target.

In the optimal mapping, the level of conversion is denoted by three levels of A through C (A>B>C) with respect to each of mapping elements (color conversion elements) of a hue conversion amount, a gradation number in the hue direction, a lightness conversion amount, a gradation number in the lightness direction, and a compression rate.

The degree of conversion for each mapping element is set as follows. Firstly, degrees of conversion are classified into three categories based on the intent, the print object, and the printing type. The first category is “saturation”, “vividness”, and “CAD”, the second category is “perceptual”, and “monitor fidelity”, and the third category is “relative”, and “photograph”.

In the first category, the hue conversion amount is set larger than that of the second category and that of the third category. Therefore, setting is performed in such a way that, based on the results of the analysis of the primary color characteristics, the larger the color difference in the primary color between the source device and the destination device, the more the gradation number in the hue direction is set to be increased, and the smaller the color difference in the primary color between the source device and the destination device, the more the gradation number in the hue direction is set to be decreased. The lightness conversion amount is set such that, the larger the lightness difference in the primary color between the source device and the destination device, and the higher the γ value, the more the conversion amount is set to be increased. Further, when the CAM information is included in the result of the analysis, the gradation number in the hue direction is set to be smaller in order to maintain the input gradation number.

In the second category, the gradation number in the hue direction, and the gradation number in the lightness direction are set larger than those of the first category and the third category. Therefore, based on the result of the analysis of the primary color characteristics, the larger the color difference in a primary color between the source device and the destination device, the more the hue conversion amount and the lightness conversion amount are set to be increased, however, the conversion amounts are set smaller than those of the first category. Further, the higher the γ value, the more the gradation number in the hue direction and the gradation number in the lightness direction are set to be increased.

Unlike the settings of the first category and the second category, in the third category, the mapping method is not determined based on the result of the analysis of primary color characteristics, but is determined on the basis of the results of the analysis of the color reproduction target, the γ value, and CAM information. The hue conversion is performed when the hue target is set, and it is set such that the higher the γ value, the more the gradation number is increased. Further, the lightness conversion amount is set to be smaller than those of the first category and the second category.

As described above, even when the characteristics of the source device and the destination device are different from each other, an optimal color reproduction that realizes the color reproduction target can be performed by determining the mapping method based on the mapping table data 30 in which the degree of conversion which has been set.

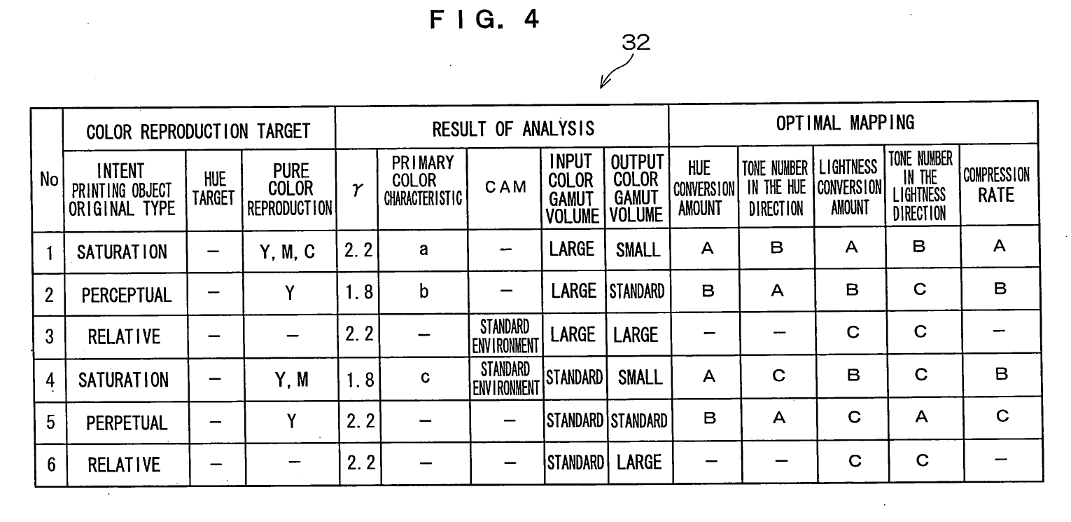

FIG. 4 shows one example of mapping table data that enables obtaining the same shades of color in each of the destination devices even when the result of the color conversion is output to different destination devices. By determining the mapping method based on a mapping table data 32 shown in FIG. 4, the destination devices may have the same shades of color even when the destination devices are different from each other. The mapping table data 30 shown in FIG. 3, and the mapping table data 32 shown in FIG. 4 may be configured to be stored in the memory 28 beforehand. In this case, the optimal color conversion according to a desired color reproduction intent may be realized by a user selecting a desired color reproduction intent, and performing color conversion using a mapping table data corresponding to the selection.

The mapping method will be explained herebelow. As mapping methods for controlling the compression rate, the gradation number in the hue direction, and the gradation number in the lightness direction, a method such as the method described in JP-A No. 2005-191808 may be applied. A compression coefficient Cnl1 in the above compression method is included as a variable in a nonlinear function for converting an input image signal into an output image signal, and is a variable which specifies a compression rate of a conversion vector. Therefore, the compression coefficient Cnl1 is specified based on a distance between a target point (achromatic color point) on the conversion vector and a point representing the input image signal.

In nonlinear compression and decompression processing using the above method, a distance L′out between the achromatic color point on the conversion vector and the output image signal can be obtained by using the following nonlinear functions shown as formulae (1) and (2), based on: distances Lin and Lout which are respective distances from the achromatic color point on the conversion vector to a boundary point of an input color reproduction range and from the achromatic color point on the conversion vector to a boundary point of an output color reproduction range, a distance L′in which is a distance from the achromatic color point to the point representing the input image signal, and the compression coefficient Cnl1 which is set according to the color reproduction intent and the subject for color conversion.

L′out=L′in×(Lout/Lin)^{f(x)} (1)

f(x)=(L′in/Lin)^{Cnl1} (2)

The compression rate and the gradation number may be changed by changing the compression coefficient Cnl1.

As an example of a mapping method controlling the above-described hue conversion amount, a method described in JP-A No. 2005-184601 may be applied. In this method, the hue conversion is performed according to a predetermined hue conversion function. In the hue conversion function, the hue is changed by changing the degree of hue conversion according to the chroma of the input image signal, such that the hue is changed more in a high chroma range while the hue is changed less in a low chroma range. The hue conversion function includes a compression coefficient as a variable, which is set for the purpose of assigning weight in the chroma direction according to the degree of hue conversion. To give a specific example, the following exponential function shown as a formula (3) can be used as the hue conversion function.

Cout=Cin−Cdif×(Cdata/Cmax)^{Cnl2} (3)

In the above formula (3), Cout is a hue angle in the output image signal, Cin is a hue angle in the input image signal, Cdif is a maximum movement amount of chroma and hue, Cdata is a chroma in the input image signal, and Cmax is a chroma at the maximum chroma point. Further, Cnl2 is a compression coefficient for weighting, and is a nonlinear coefficient for adjusting the nonlinearity. The hue movement amount may be changed by changing the compression coefficient Cnl2.

As an example of a mapping method controlling the above-described lightness conversion amount, a method described in JP-A No. 2005-184602 may be applied. In this method, the lightness conversion is performed according to a predetermined lightness conversion function. In the lightness conversion function, the lightness is changed by changing the degree of lightness conversion according to the chroma of the input image signal, such that the lightness is changed more in a high chroma range and the lightness is changed less in a low chroma range. Further, the above lightness conversion function includes a compression coefficient as a variable, which is set for the purpose of assigning weight in the chroma direction according to the degree of lightness conversion. As a specific example, the following exponential function shown as a formula (4) can be used as the lightness conversion function.

Lout=Lin−Ldif×(Cin/Cmax)^{Cnl3} (4)

In the above formula (4), Lout is a lightness value after conversion, Ldif is a lightness adjustment value, Cin is a chroma in the input image signal, and Cmax is a chroma at the maximum chroma point in the color reproduction range of the source device. FurtherCnl3 is a compression coefficient for weighting, and is a nonlinear coefficient for adjusting the nonlinearity. The lightness conversion amount may be changed by changing the compression coefficient Cnl3.

Thus, the mapping method is determined at step 110 by setting the above-described conversion functions and/or the above-described compression coefficients on the basis of the hue conversion amount and the like, which have been determined based on the mapping table data as described above.

At step 112, the determined mapping method, that is, the conversion functions and/or the compression coefficients, which have been set on the basis of the hue conversion amount and the like, are output to the color gamut compressor 14.

Thereby, the image signal in Lab color space, which is output from the input color space converter 12, is converted by the specified mapping method in the color gamut compressor 14 to output the signal to the output color space converter 16. In the output color space converter 16, the input image signal in a Lab color space is converted into the CMYK image signal. Here, setting of black generation may be changed according to the printing types acquired at step 106.

Further, color conversion coefficients in a lookup table for converting the input image signal (for example, RGB, or CMYK) into the output image signal (for example, CMYK), or in a lookup table and the like for outputting the result of the conversion to the color gamut compressor 14 may be generated based on the determined mapping method, that is, the conversion functions, the compression coefficients and the like which are set on the basis of the hue conversion amount and the like.

As described above, in the present embodiment, the source profile and the output profile are analyzed, and based on the result of the analysis, the color conversion method to be performed is determined and color conversion is performed. Accordingly, the color conversion may be performed in a manner that maintains the principal characteristics of the source device and the destination device, even if the characteristics of the source device and the destination device are greatly changed. Further, similar color reproduction may be realized in the destination device even if the color reproduction range of the source device is greatly changed.

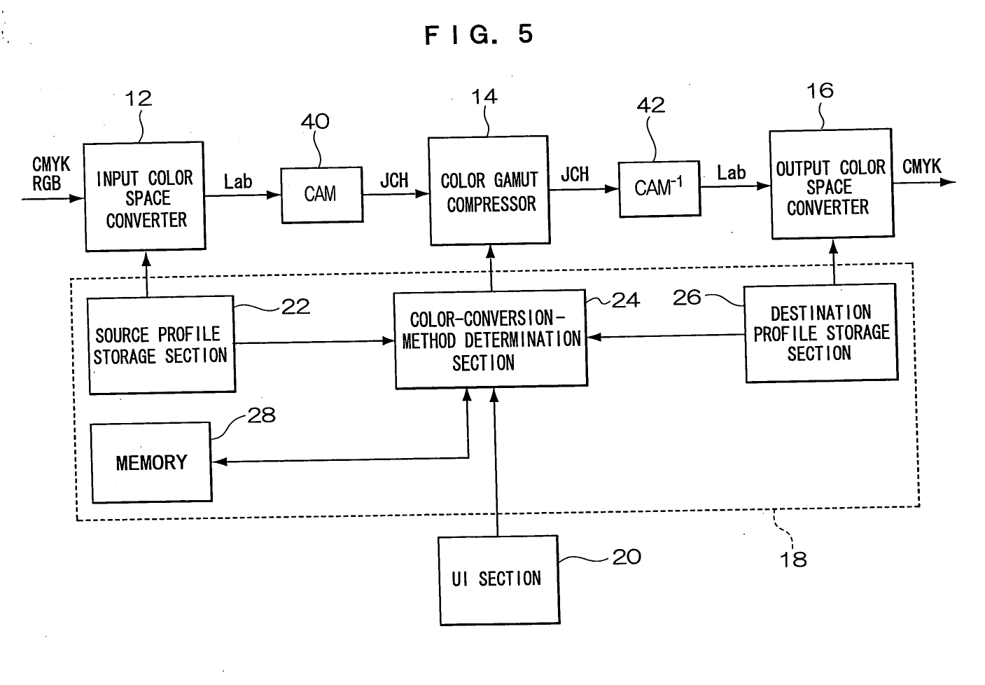

Moreover, the present invention may also be configured such that, as shown in FIG. 5, a CAM conversion section 40 for CAM transformation considering ambient light and the like is provided between the input color space converter 12 and the color gamut compressor 14, and a CAM inverse transformation section 42 is provided between the color gamut compressor 14 and the output color space converter 16.

The foregoing description of the exemplary embodiment of the present invention has been provided for the purpose of illustration and description. It is not intended to be exhaustive or to limit the invention to the precise form disclosed herein. Obviously, many modifications and variations will be apparent to a practitioner skilled in the art. The exemplary embodiments were chosen and described in order to best explain the principles of the invention and its practical applications, thereby enabling others skilled in the art to understand the invention according to various embodiments and with various modifications as are suited to the particular use contemplated. It is intended that the scope of the invention be defined by the following claims and their equivalents.

What is claimed is:

1. A color conversion device, comprising:
an analyzer that analyzes color reproduction characteristics of a source device based on a source profile, and analyzes color reproduction characteristics of a destination device based on a destination profile;
a determination section that, based on the result of the analysis, determines a color conversion function for converting an input image signal to an output image signal; and
a converter that converts the input image signal to the output image signal, based on the determined color conversion function.

2. The color conversion device of claim 1, wherein the analyzer analyzes, as the color reproduction characteristics of the source device, at least one of a gradation characteristic, a primary color reproduction characteristic, a CAM, an intent, and/or a color gamut volume of the source device.

3. The color conversion device of claim 1, wherein the analyzer analyzes, as the color reproduction characteristics of the destination device, at least one of a gradation characteristic, a primary color reproduction characteristic, the reproducibility in a low lightness range, and/or a color gamut volume of the destination device .

4. The color conversion device of claim 2, wherein the analyzer analyzes the color gamut volume by comparing the volume of a predetermined reference color gamut with at least one of: the volume of the whole color gamut; the volume between the hues of predetermined primary colors; the volume of the color gamut with a higher lightness than the maximum chroma; and/or the volume of the color gamut with a lower lightness than the maximum chroma.

5. The color conversion device of claim 2, wherein the analyzer analyzes the gradation characteristic by analyzing the gradation reproducibility of at least one of saturated colors and/or intermediate colors of the primary colors.

6. The color conversion device of claim 1, further comprising a storage section storing mapping table data representing relations between at least analyzed items of the analyzer and the color conversion degrees of predetermined color conversion elements,
wherein the determination section determines color conversion degrees corresponding to the result of the analysis, and determines the color conversion function based on the color conversion degrees.

7. The color conversion device of claim 6, wherein the storage section stores a plurality of mapping tables, which are different from one another depending on the color reproduction intent.

8. The color conversion device of claim 1, wherein the determination section determines at least one of a hue conversion method, a lightness conversion method, and/or a color gamut compression method, based on at least one of the result of the analysis and/or the color reproduction intent.

9. A color conversion method, comprising:
analyzing the color reproduction characteristics of a source device based on a source profile, and analyzing the color reproduction characteristics of a destination device based on a destination profile;
determining a color conversion function for converting an input image signal into an output image signal based on the result of the analysis; and
converting the input image signal to the output image signal based on the determined color conversion function.

10. A storage medium storing a program to cause a computer to execute color conversion processing, the color conversion processing comprising:
analyzing the color reproduction characteristics of a source device based on a source profile, and analyzing the color reproduction characteristics of a destination device based on a destination profile;
determining a color conversion function for converting an input image signal to an output image signal based on the result of the analysis; and
converting the input image signal to the output image signal based on the determined color conversion function.

11. A device that generates a color conversion coefficient, comprising:
an analyzer that analyzes the color reproduction characteristics of a source device based on a source profile, and analyzes the color reproduction characteristics of a destination device based on a destination profile;
a determination section that determines a color conversion function for converting an input image signal to an output image signal based on the result of the analysis; and
a generating section that generates a color conversion coefficient for converting the input image signal to the output image signal, based on the color conversion function determined in the determination section.

12. A method for generating a color conversion coefficient, comprising:
analyzing the color reproduction characteristics of a source device based on a source profile, and analyzing the color reproduction characteristics of a destination device based on a destination profile;
determining a color conversion function for converting an input image signal to an output image signal based on the result of the analysis; and
generating a color conversion coefficient for converting the input image signal to the output image signal, based on the determined color conversion function.

13. A storage medium storing a program to cause a computer to execute processing for generating a color conversion coefficient, the processing for generating a color conversion coefficient comprising:
analyzing the color reproduction characteristics of a source device based on a source profile, and analyzing the color reproduction characteristics of a destination device based on a destination profile;
determining a color conversion function for converting an input image signal to an output image signal based on the result of the analysis; and
generating a color conversion coefficient for converting the input image signal to the output image signal, based on the determined color conversion function.

14. A color conversion device, comprising:
a device that generates a color conversion coefficient according to claim 11; and
a converter that converts the input image signal to the output image signal based on the generated color conversion coefficient.
